(19) United States
(12) Patent Application Publication
(10) Pub. No.: US 2012/0232323 A1
(43) Pub. Date: Sep. 13, 2012

(54) Engineered quartzification of asbestos for remediation, detoxification and containment, and for production of solid-surfacing and decorative uses

(76) Inventor: Barbara Pfeffer Billauer, Washington, DC (US)

(21) Appl. No.: 13/064,211

(22) Filed: Mar. 11, 2011

(51) Int. Cl. C04B 18/16; A62D 3/00; B09B 3/00

(52) U.S. Cl. 588/254

(57) ABSTRACT

This invention pertains to a method for remediating, detoxifying and containing various types of asbestos fibers and asbestos containing materials, such as crocidolite (and other forms of Riebeckite), and tremolite. The end-product of the method may be reclaimed or recycled as useable surfacing, structural and decorative materials. In some embodiments of the invention some end-products of the process may be used as a synthetic gemstone, counter-surfacing material cutting tool, resin for manufacture of furniture products, while others may be used to reclaim natural sand. In one embodiment of this invention crocidolite or other forms of reibeckite or tremolite asbestos debris in loose form or as a component of asbestos cement or other asbestos containing products is converted to a form of engineered quartz, yielding as a synthetic form of the gemstone Tiger's Eye or Hawk's eye. This end-product bears unique and enhanced aesthetic qualities over other types of engineered quartz, called chatoyancy (an optical effect that arises either from the fibrous structure of a material or from fibrous inclusions or cavities and is sometimes likened to the sheen off a spool of silk). The end product therefore achieves luminous more natural-looking effect, while retaining the other desirable features of engineered quartz, such as strength, imperviousness to heat, and resistance to acids and microbial contamination, and reduces the need for the addition of decorative resinous materials which diminish the endurance features of the material.

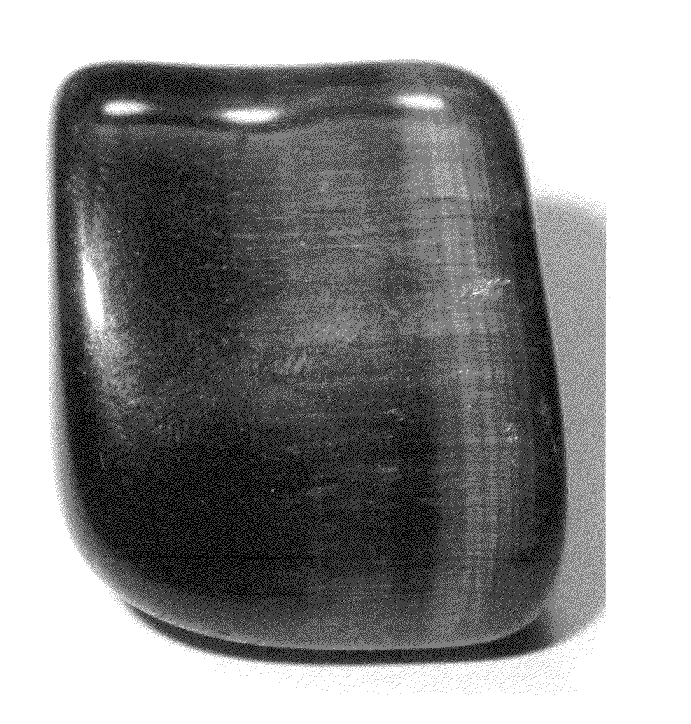

### FIELD OF INVENTION

This invention is directed to a process for creating a decorative surface with certain light-reflective qualities, called chatoyancy, in engineered stone materials.

This invention is directed to enhancing the decorative surfaces of engineered stone materials and allowing it to have a more natural look by creating a new form of engineered stone which changes in color or luster depending on the angle of light reflecting on the surface.

This invention is directed to enhancing the natural-ness and aesthetic appeal of engineered stone by allowing for the appearance of well-defined bands or streaks threads of light across the surface.

This invention is directed to enhancing the uses of engineered stone by the incorporation of the chatoyancy characteristic, which can be further enhanced by cutting the material in a cabochon style.

This invention is directed to improving the features of engineered stone by the incorporation of increased resistance to acid, heat and hardiness, while reducing its weight.

This invention is also directed at remediation, detoxification and amelioration of certain types of asbestos, namely crocidolite and tremolite and other forms of reibectite or and/or asbestos by encapsulating it in a solid, non-degradable matrix via a pressure-molding technique.

### BACKGROUND OF THE INVENTION

Engineered stone products may be produced by a well known procedure commercialized by Breton S.p.A. of Castello di Godego, Italy, so-called “Breton Stone”. In this technology, resin precursors are blended at low weight percentages with crushed stone aggregate to provide a relatively dry mass of material, distributed evenly on a support carrier, vibro-compacted under vacuum and then cured to yield a rigid product. A process used to practice this technology is disclosed by Toncelli in U.S. Pat. No. 4,698,010. Breton Stone materials are disclosed for use as flooring tile. Subsequent improvements to the technology, such as U.S. Pat. No. 6,387,985 to Wilkinson and Burchfield, increased the uses of the material for general surfacing, particularly making it suitable for use as a countertop. Zodiaq® Quartz Surfacing from DuPont is an example of a commercially available engineered stone, as is CaesarStone®. Whether the product is floor tile or countertop, the slab produced by the Breton Stone process requires calibration to render it planar and uniform in thickness, as well as to reveal the aesthetic features of the product. This is followed by polishing to render the surface glossy.

As described in U.S. Pat. No. 6,387,985, harmless substances and materials generally regarded as aesthetic-enhancing substances may be added for a decorative effect. Decorative additives are also distinguished from stone fillers by the amount present in the composition. The crushed natural stone filler acts as an aggregate and is typically present in a range from 85% to 95% by weight. Decorative additives such as gemstones, metal flake or filings, micas, seashells, pearls, colored or transparent polymeric particles, mirrored particles and pigments have been added in attempts to increase the visual appeal and aesthetic qualities of the engineered stone. However, these quantities typically have not exceeded about 5% by weight, and preferably, do not exceed 2% by weight as their presence diminishes some of the other desirable qualities of the stone, such as strength.

Synthetic stone products are well known and are in great demand due to their ability to be manufactured in a wide variety of patterns and colors that cannot be consistently found in nature. Such compositions are for example described in U.S. Pat. Nos. 4,664,954, 4,085,246, 4,678,819, 4,734,452, 5,043,377 and 5,055,327. The disadvantage of the described stone compositions is that when molded they result in surfaces which reflect the properties of the resin more than the properties of the aggregates contained in the compositions which limits the aesthetic appeal.

Further, in general synthetic stone compositions based on high percentages of resins are not suitable for purposes requiring strength, chemical resistance or weatherability.

This invention provides a stone composition with inclusions of fibrous minerals that has improved properties over many natural stones and is further improved over simulated stones in its abrasion resistance, hardness, heat resistance, chemical resistance, especially to acids and weatherability, as well as in aesthetic properties. These characteristics are particularly important for floor and outdoor applications as well as for high-end and decorative uses.

This invention introduces the inclusion of crocidolite asbestos fibers (or other asbestos fibers that can contribute to the chatoyancy characteristic to the stone matrix). The introduction and use of the asbestos fiber may substitute for most or all of the decorative materials heretofore added, as well as and for some resin fillers and can reduce the content of the stone aggregate. By so doing, it adds additional strength-contributing characteristics and resistances to heat, acid and abrasion, which typical resins and decorative materials diminish in the final product. It also reduces the weight of the overall product without detracting from strength or durability, while adding the chatoyancy feature.

It is well known that the hazardous properties of asbestos are a function of their long fibrous shape (and sharp ends) as opposed to their chemical makeup. Because amphibole asbestos (the most common being amosite and crocidolite) have longer and thinner fibers (they are sharper and more needle-like than the more ubiquitous chrysotile, known as serpentine asbestos because of its curly structure), the amphiboles are both stronger as well as more toxic than chrysotile, a fact reflected in the different safety standards of permissible exposure enacted in most countries regarding the different varieties of asbestos, and hence remediation methods are more difficult, costly and cumbersome.

The detoxification and remediation of asbestos by transforming it into an inert non-asbestiform material has long been recognized. One process that enjoys several patents is vitrification, where the asbestos is “glassified,” traditionally via the use of high heat, generally listed as 1380 degrees Fahrenheit or above for at least an hour. While the “vitrified” asbestos has been certified as “safe” by various international laboratories, the end-product lacks in aesthetic appeal, making its use unattractive from a cost-standpoint.

Further, the vitrification process for crocidolite must employ higher temperatures due to the hardiness of the material as compared to the more common varieties of chrysotile and amosite. One method utilizing reduced process temperatures is described in U.S. Pat. No. 4,678,493. In that patent, asbestos waste is converted to glass (i.e., vitrified) by mixing the asbestos waste with a melt accelerator and waste glass cullet, then melting the mixture to form a glassy substance. However, it is difficult to control the vitrification process unless the amount of asbestos waste entering the process and ensure it is kept low relative to the amount of glassformers required. Thus, the vitrification of asbestos is difficult to render economically feasible.

Other methods of transforming asbestos into non-mineralized inert substances have also been patented. One method is described in U.S. Pat. No. 5,096,692, the conversion of asbestos waste, relies on the demineralization of the asbestos to achieve the safety standard. However, that method, too, does not produce a commercially viable end-product, reducing the cost-effectiveness of the process.

Disposal methods for asbestos waste typically involve landfill in a dump site specifically designed to contain only asbestos waste or in hazardous waste landfill sites. Owing to landfill bans, disadvantages associated with committing material to landfill dumping, and a resolve by regulatory authorities to minimize utilization of landfills of all types, there is a need in the art for a process which will convert asbestos waste into a non-toxic product without the disadvantages associated with the prior art techniques.

This invention is therefore an improvement on the prior state of the art of asbestos remediation, and is especially suitable for crocidolite asbestos, which requires even more stringent disposal standards. Rather than relying primarily on heat to “melt” the asbestos, as does the prior state of the art, this invention relies on the pressure-molding function of the quartzification process. Because the invention seals and permanently embeds crocidolite, (as well as other forms of asbestos) coating the sharp fibrous ends within the quartz matrix (which is known to be amongst the hardiest and least susceptible to weathering according to the Goldick dissolution series) via a pressurization method, it renders the asbestos-fibers inert, and at the same time enhances an already commercially viable product, thereby constituting a distinct advance in two different arts.

While the quartzification process described in paragraphs 0006-0008 produces aesthetically attractive and commercially viable surfacing materials, the surfaces of the engineered stone materials prepared via the current state of the art lack various aesthetic qualities. To a certain degree, this has been remedied by the inclusion of decorative elements and materials, however the amount of their inclusion must be limited, as too much would diminish the hardiness of the final product. Further, the luminousity characteristic of natural quartz is also lacking in products produced under the current state of the art. This invention then improves on the aesthetic appeal of engineered quartz while simultaneously providing a means to detoxify or render inert crocidolite and other forms of asbestos, especially those generally considered the most hazardous and difficult to detoxify and remediate, relying on the tightly embedded nature of the final matrix (solid surfacing material or decorative material) to achieve the detoxification.

Natural quartz is a crystalline form of silicon dioxide (SiO2) and is one of the hardest substances known to man. It comes in clear, translucent or colored varieties. Common translucent colored varieties include citrine, rose quartz, amethyst, smoky quartz, milky quartz, and others. Common opaque forms are known as agate, sard, onyx, carnelian, heliotriope or jasper.

Some forms of quartz contain inclusions of other materials or variants, giving the stone attractive colorings or contrasting bandings of color. Some of these variants are called chatoyant. minerals and they display luminous bands, which appear to move as the specimen is rotated. Such minerals are composed of parallel fibers (or contain fibrous voids or inclusions), which reflect light into a direction perpendicular to their orientation, thus forming narrow bands of light.

One form of natural quartz, called Tiger's eye (also called Tigers eye or Tiger eye) is a chatoyant (lustrous, light reflecting) gemstone that is usually a metamorphic rock that is a golden to red-brown color, with a silky luster. It is a classic example of pseudomorphous replacement. The the silica in this stone is replaced in whole or part by the inclusion fibrous crocidolite (blue asbestos). An incompletely silicified blue variant is called Hawk's eye or Cat's eye.

The fibrous nature of the asbestos is entirely responsible for the chatoyance of the stone. In the case of crocidolite, the crystalline structure is prismatic, with refractive indices ranging from approximately 1.67-1.717. These features contribute to the unique manner in which the fibrous material reflects light.

### SUMMARY OF THE INVENTION

The present invention incorporates the features that transform ordinary quartz into Tiger's Eye, Hawk's Eye or Cat's eye, incorporating the unusual quality of chatoyancy, by adding crocidolite (or other forms of asbestos) to the engineered stone matrix. In one embodiment of the present invention, as in the case of Hawk's eye or Cat's eye, the crocidolite is not completely silicified and the asbestos fibers remain embedded in the matrix. Because they are firmly embedded and the needle like ends encased in the matrix, in both the natural form and in the present invention they are not hazardous.

The present invention, therefore, represents an improvement of two prior states of art, one directed to formation of engineered stone containing naturally occurring stone particles or aggregates (such as marble or quartz or granite) and a binder, (the prior art being a process of engineered stone comprised of basically four steps, (1) combining stone aggregate with a binder to form a homogenous mixture to create a three dimensional shape, (2) employing a vacuum to remove air from the homogenous mixture of stone aggregate-particles and binder, (3) compressing and vibrating the stone-aggregate particles and binder and (4) solidifying the binder to form a solid article, and the other directed toward asbestos remediation.

The present invention introduces the improvement in the process by introducing fibrous forms of asbestos such as crocidolite to the crushed stone aggregate. This addition allows for decorative effects in the end-product without the need for the traditional decorative materials. By reducing the amount of traditional decorative materials, substituting the fibrous crocidolite instead (or in addition), the end-product retains a higher degree of hardness and other optimal elements of the natural quartz or granite-like material, along with enhanced resistance to chemicals such as acids, along with the unique chatoyancy.

The present invention relies on fibrous structure of the asbestos and its silicacious nature, in this embodiment crocidolite asbestos (Chemical formula: Na2Mg1.5Fe2+1.5Fe3+2[Si8O22](OH)2−Na2Fe2+3Fe3+2[Si8O22](OH)2) to reduce the amount of the standard quartz or other silicacious materials, normally derived from stone, which are needed in the mixture, as well as eliminating or reducing the need for decorative additives (which weaken the final structure) to achieve aesthetically pleasing results. By relying on the natural color of the asbestos (blue or brown) as well as the fibrous nature, which reflects light to convey the desired aesthetic qualities, the need for extrinsic additives is reduced or eliminated.

The present invention first requires that asbestos containing waste or loose asbestos fibers be collected. Water sprays (with surfactant additives, such as soap) are usually applied to control fugitive dusts which might be generated during the removal process. The wet asbestos material is then transported in polyethylenedisposable bags specifically designed for the purpose, and those collecting the dusts are outfitted with appropriate personal protective devices.

Asbestos waste materials removed in such a manner are composed of asbestos fibers and usually contain other fibers of inorganic or organic origin along with other materials such a Portland cement, gypsum, plaster, dolomite, and a variety of silicates. The term asbestos waste is used herein to include the asbestos mixtures mentioned above as well as any asbestos mineral fibers, including the minerals chrysoltile, amosite, anthophyllite, crocidolite, actinolite, tremolite and other commercial and industrial asbestos minerals collectively known as asbestos, and includes mixtures of asbestos mineral fibers with additive or matrix substances including inorganic and organic materials.

Once the asbestos waste or fibers or debris is collected, it must be typed (usually by X=ray diffraction, but other methods such as Polarized Light Microscopy (PLM), or occasionally Scanning Electron Microscopy (SEM) may be amenable) to determine if the preferential form of asbestos is present (e.g crocidolite, actinolite or tremolite, and occasionally chrysotile). Often the asbestos is typed prior to removal, such that this invention is particularly well-suited for areas with known crocidolite asbestos contamination. Since crocidolite asbestos is a blue (fibrous) mineral, the visual appearance coupled with the knowledge that asbestos was used at a particular site is the first indicator that the site may be amenable to this type of remediation.

Once the asbestos containing material is either identified as pure fibrous materials, or contained in a loose matrix with other silicacious materials such as marble or cement, it can be pulverized or aggregated into homogenous sized particles which are added to materials generally used in the engineered stone process. The preferred materials for that process are quartz or marble aggregates, although sand (the precurser to stone) can be used. These materials occur naturally in particulate form in particle sizes, which are suitable for use in forming the composites of the present invention. Generally the particles in initial mineral aggregate have a size ranging from 0.2 to 2 mm. and the asbestos containing material should be pulverized to be compatible with the stone or sand matrix.

Because of the nature of the asbestos fibers, personal protective equipment should be mandated through or until the phase of pressure-molding operation, and/or the preliminary stages of the operation (at least prior to the pressurization/molding) may be conducted in negative pressure assembly or manufacturing units (or other alternatives such as glove-bagging operations can be employed).

Once the matrix of asbestiform material and quartz or stone aggregate is composed (based on aesthetic variants and preferences) and the desired proportion or mixture of the asbestiform and quartz or stone granules is determined, a resin may be added, such as those known in the industry as gel-coat resins. Either polyester or acrylica or polyurethane resins can be used. The polymerization of the matrix resin is usually initiated by the addition of a free radical initiator such as methyl ethyl ketone peroxide, t-butyl perbenzoate, and lauroyl peroxide, or 2,2′-azobisisobutyronitrile. Binders are also added, and can be employed in either or both the initial and final molding steps, the exact relative composition is determined by the aesthetic nature of the desired final product, since the addition of the asbestiform material reduces the need for materials that detract from the hardiness or longevity or resistance of the product.

Rather than relying on heat, as the vitrification and other asbestos-demineralization techniques do, this invention relies on pressure (compaction) along with vibration and vacuum extraction to “bind” the asbestos into the rest of the material, thereby “encapsulating” the sharp fibers within the matrix. In so doing the process detoxifies the material, while adding the fibrous elements to the final substrate (ie the aggregate silicacious substance) that allows for the unique light-reflecting capacities.

Well known commercial equipment can be employed in producing the composites of the present invention. Preferably the vibration and compaction of the aggregate mixture under a vacuum, which removes the air from the aggregate in the mixture, is conducted in machines such as ‘vacuumvibropresses’ which are commercially available. In the alternative the vibration treatment of the aggregate mixture can be a separate initial step. The compression presses employed generally are capable of exerting pressures of up to 10,000 psig. Optimum pressures will vary with the size and type of the mineral particles in the aggregate and are best experimentally determined on the basis of the desired end product properties. Vacuum pumps useful in the present invention are generally classified as medium vacuum pumps and should be able to achieve vacuums in the range of 0.1 to 1 pascal.

Additional chemical processes can be added to the process to enhance color and best display chatoyancy. These processes include bleaching, oxidizing, treatment with gentle heat, and treatment with nitric and other acids.

1. As an independent claim: an asbestos remediation and detoxification method that results in and transforms the asbestos into a commercially viable and safe end-product, needing no further disposal or remediation.

2. As a second independent claim, a method of enhancement to the current process of creating engineered stone surfacing that adds visual appeal and luminousity to the final product, such as having the characteristic of certain light reflecting properties called chatoyancy.

3. Incorporating claim two, an enhancement to the current method of producing engineered stone surfacing that eliminates the need for decorative inclusions that would otherwise compromise or reduce the hardiness of the engineered stone.

4. As a third independent claim, and incorporating the prior two claims a variation of the current method of creating engineered stone that reduces the weight of the final product without sacrificing strength, hardiness or weatherability by dramatically varying the composition of the stone-resin-binder matrix through the inclusion of asbestiform fibrous minerals, such as crocidolite, into the formula.
